(19) United States
(12) Patent Application Publication
(10) Pub. No.: US 2015/0082840 A1
(43) Pub. Date: Mar. 26, 2015

(54) FILE CABINET DRAWER LOCKING DEVICE

(71) Applicants: Dennis Sam TRINH, Maineville, OH (US); Albert Long TRINH, Maineville, OH (US); Toan TRINH, Maineville, OH (US)

(72) Inventors: Dennis Sam TRINH, Maineville, OH (US); Albert Long TRINH, Maineville, OH (US); Toan TRINH, Maineville, OH (US)

(21) Appl. No.: 14/032,712

(22) Filed: Sep. 20, 2013

(51) Int. Cl. E05B 65/44

(52) U.S. Cl. CPC E05B 65/44
USPC 70/14

(57) ABSTRACT

A locking system for the file drawers of a standard file cabinet, and in particular a steel-constructed file cabinet. The system includes a locking device and a locking means, the locking device having an elongated bar that includes a locking end and an opposing attaching end. The attaching end has an upturned wall at its distal end that adhesively or magnetically attaches to an interior vertical wall along the upper edge of the file drawer frame. The locking means is a ratcheting lock that releasably and ratchetingly engage teeth along an edge of the elongated bar. The locking end of the attached locking device extends through an upper slot when the file drawer is closed, and the ratcheting lock secures the locking device and the closed drawer from opening.

### FIELD OF THE INVENTION

The present invention relates generally to a locking device for drawers of a file cabinet.

### BACKGROUND OF THE INVENTION

Lower-priced file cabinets are commonly sold without a built-in lock. Some other cabinets may originally have a built-in lock, but the keys may be malfunctioning or the key may be lost. In these cases, a replacement lock provided by a locksmith may be expensive. It is desirable to have an inexpensive non-built-in locking device to lock a drawer of the file cabinet, in order to store and secure valuable, sensitive or confidential documents.

### SUMMARY OF THE INVENTION

The present invention provides a locking system and a locking device for a file drawer of a standard file cabinet, and in particular a steel-constructed file cabinet. The locking system includes the locking device and a locking means. The locking device includes an elongated bar that includes a locking end and an opposed attaching end, and means for engaging a portion of file drawer frame that is fixed to the attaching end. The locking system of the invention is used with a file cabinet having a file drawer frame, wherein an upper portion of a file drawer frame includes an interior vertical wall that is engaged by the engagement means of the locking device. A locking means is then applied and secured to the locking end of the locking device that extends forward through an upper slot between the file drawer and the file drawer frame. The locking means prevents the locking device from being pulled through an upper slot formed when the file drawer is closed within the file drawer opening defined by the drawer frame, and prevents the file drawer from being pulled open.

In one aspect of the invention, the engagement means includes an upturned wall that extends perpendicularly from the elongated bar at the attaching end. The upturned wall has a laterally extending dimension that is at least as wide as, and typically wider than, the elongated bar, to provide a stable engagement with the interior vertical wall. The upturned wall has a height that covers at least a portion of the height of the interior vertical wall of the drawer frame, and typically extends to or beyond the upper edge of the interior vertical wall of the file drawer frame.

In another aspect of the invention, the upturned wall of the locking device has a forward-facing surface that faces the locking end. A fastener can be provided that is fixed or attached to the forward-facing surface of the upturned wall, for attachment to the interior vertical wall of the file drawer frame. The fastener is selected from the group consisting of a pressure-sensitive adhesive layer, a hook and loop mechanical fastener, and a magnetic fastener.

The locking device can optionally include a downturned wall extending perpendicularly from the attaching end and substantially parallel with the upturned wall, to prevent manipulating of the locking device through an upper slot of the drawer opening after the locking means has been applied and secured to the locking device.

The present invention also provides an engagement means that includes a hinge fixed to the attaching end of the elongated bar, and a hooking member extending from the hinge. The hooking member includes an extending member having a proximal end fixed to the hinge, and a distal end, and a return clasping member extending from the distal end of the extending member and extending toward the hinge. The return clasping member is spaced apart from the extending member by a gap having a dimension, wherein the gap accommodates the thickness of the vertically extending interior wall of a file cabinet when the return clasping member is hooked over the top edge of the interior vertical wall.

The present invention also provides an engagement means that includes a hooking member fixed to and extending perpendicularly from the attaching end. The hooking member includes an extending member having a proximal end fixed to the attaching end, and a distal end, and a return clasping member extending from the distal end of the extending member and extending toward the attaching end. The return clasping member is spaced apart from the extending member by a gap having a dimension, wherein the gap accommodates the thickness of the vertically extending interior wall of a file cabinet when the return clasping member is hooked over the top edge of the interior vertical wall.

In an aspect of the invention, the locking end can include a plurality of teeth along a side edge of the elongated bar. The locking means can comprise a ratcheting lock that engages ratchetingly the teeth to secure the locking means to the locking end of the locking device. The ratcheting lock ratchetingly and releasably engages the row of teeth along an edge of the elongated bar. A non-limiting example of a ratcheting lock is described in U.S. Pat. No. 4,617,810, the disclosure of which is incorporated by reference in its entirety.

In a further aspect of the invention, the locking end is typically configured to extend at least about 2 inches to about 2.5 inches (about 5 cm to about 6 cm), and up to about 3 inches to about 4 inches (about 8 cm to about 10 cm), from the upturned wall. The dimension is sufficient to minimize the length of the locking end of the elongated bar that will extend away from the front surface of the file cabinet drawer when secured.

In an aspect of the invention, the attaching end can include a transverse base portion extending laterally with and parallel to the plane as the elongated bar, wherein the upturned wall or the hinge extends from a rearward edge of the transverse base portion. The transverse base portion can extend from either or both side edges of the attaching end.

The present invention also provides a method for securing closed a file drawer within a drawer opening of a file cabinet, comprising the steps of: a) opening a file drawer of a file cabinet disposed within drawer opening defined by a file drawer frame; b) securing releasably the attaching end of a locking device described herein, to a vertically extending interior wall of an upper portion of the file drawer frame of the file cabinet; c) extending forward the locking end of the locking device through the drawer opening while closing the drawer, to expose the locking end through an upper slot between the file drawer and the file drawer frame; and d) attaching a locking means to the locking end to prevent the file drawer from opening within the drawer opening.

The present invention also provides an article of manufacture comprising: a) a locking device and optionally a lock and one or more keys; b) instructions for use by a consumer of the locking device with a file cabinet, for locking and securing a drawer of the file cabinet using the locking device; and c) a package for securing together the locking device, the optional lock and one or more keys, and the instructions. The instructions can direct the consumer to attach the locking device to the file cabinet, and for closing and locking the drawer in the file cabinet.

### BRIEF DESCRIPTION OF THE FIGURES

FIG. 1 shows a first embodiment of a locking device of the invention.

FIG. 2 shows a side elevation view of the locking device of FIG. 1 to be installed into a file cabinet with the drawer in the open position.

FIG. 3 shows the locking device of FIG. 2 installed into the file cabinet with the drawer in the closed position.

FIG. 4 shows a side elevation view of the locking device of FIG. 3 with a ratcheting lock installed

FIG. 5 shows a top plan view of the locking device of FIG. 4, viewed along line 5-5.

FIG. 6 shows a second embodiment of a locking device of the invention.

FIG. 7 shows the locking device of FIG. 6 installed in a file cabinet, with the ratcheting lock installed, using a guard.

FIG. 8 shows the locking device of FIG. 1 using an alternative two-member fastener to attach the locking device to the file cabinet.

FIG. 9 shows a third embodiment of a locking device of the invention that includes a hinge and a hooking member.

FIG. 10 shows the third embodiment of the locking device of FIG. 9 with the hinge pivoted to an installed position.

FIG. 11 shows a top plan view of the locking device of FIG. 9.

FIG. 12 shows a side elevation view of the locking device of FIG. 9 in the installed position attached to the file cabinet with the drawer in the open position.

FIG. 13 shows the locking device of FIG. 12 installed into the file cabinet with the drawer in the closed position with the ratcheting lock installed.

FIG. 14 shows a fourth embodiment of a locking device of the invention that includes a hooking member.

FIG. 15 shows the locking device of FIG. 14 installed into the file cabinet with the drawer in the closed position with the ratcheting lock installed.

FIG. 16 shows an article of manufacture including the locking device, a ratcheting lock, fastener elements, and instructions for use.

### DETAILED DESCRIPTION OF THE INVENTION

As used herein, the term “forward” refers to the front face of a file cabinet, and to a direction toward the front face of the file cabinet, while the term “rearward” refers to the rear of the file cabinet, and to a direction toward the rear of the file cabinet.

As used herein, the term “vertical” or “vertically”, refers to a direction between the top surface and the bottom of a standard file cabinet, while the term “horizontal” or “horizontally” refers to a direction generally parallel with a floor or other surface on which a standard file cabinet in placed.

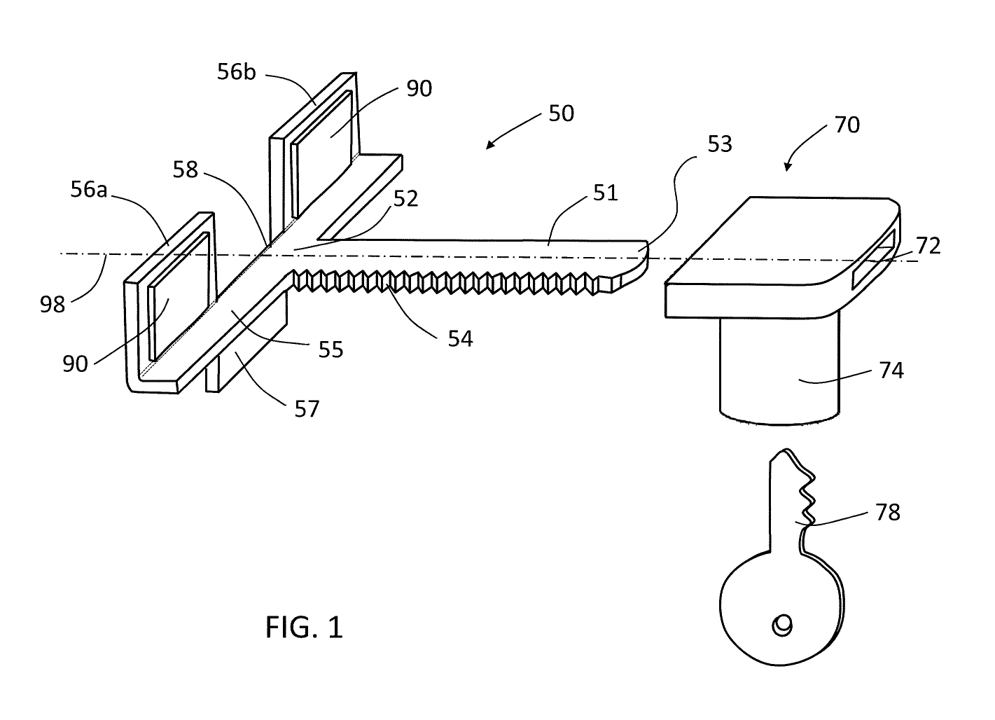

FIG. 1 shows a first embodiment of a locking device 50 including an elongated planar bar 51 having an attaching end 52 and a locking end 53. The attaching end 52 includes a transverse base 55 that extends from both side edges of the attaching end 52, and at least one upturned wall 56, illustrated as a pair of upturned walls 56a and 56b extending from the rearward edge 58 of the transverse base 55 on both sides of the bar 51, and extending in a direction transverse to the long axis 98, and perpendicular from the plane of the bar 51.

The locking end 53 comprises a rounded edge for easier insertion into the slot 72 of a ratcheting lock 70, described below. The bar 51 includes a plurality of lock engaging elements 54 (teeth or ridges) disposed along a portion of one side edge. The transverse slot 72 of the ratcheting lock 70 has a shape and size suitable to receive slidably the locking end 53 and the elongated bar 51 of the locking device, and a cylinder lock portion 74 having a keyway (not shown) to receive the blade of an operable key 78.

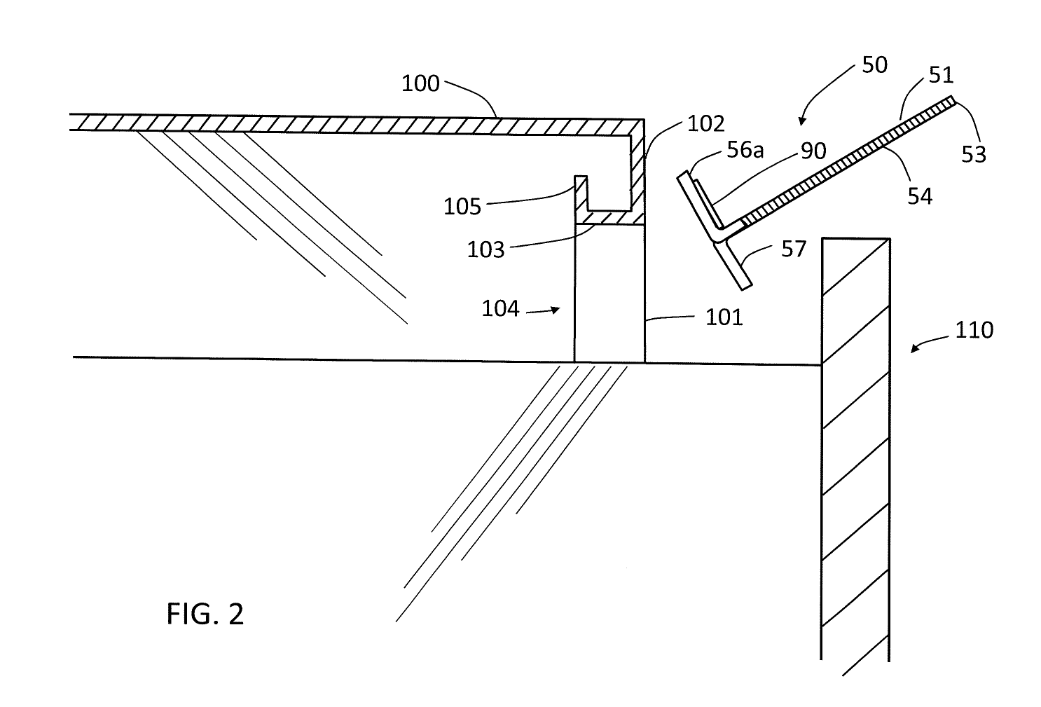

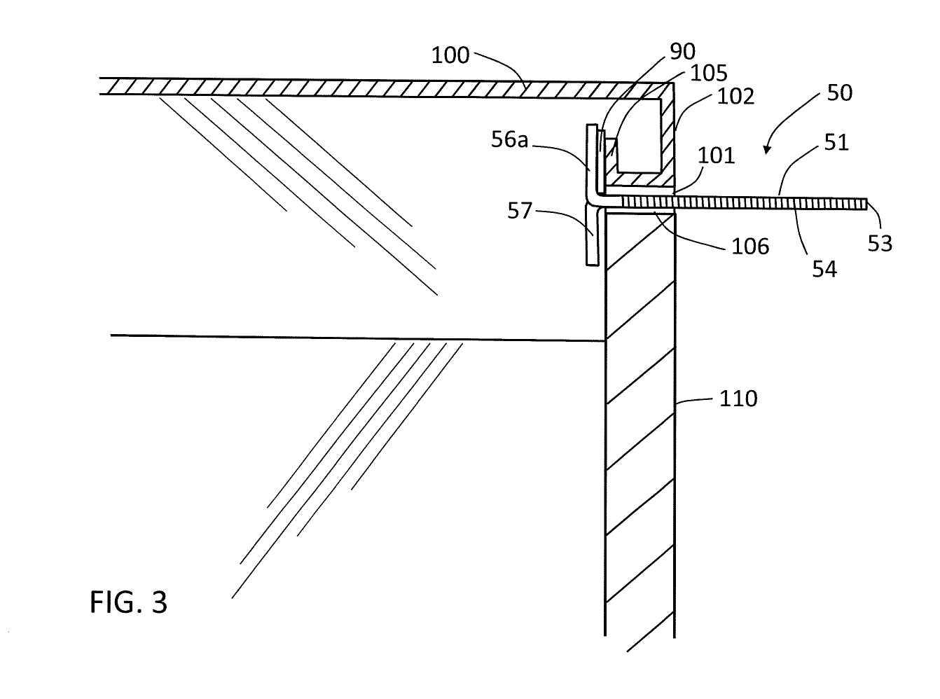

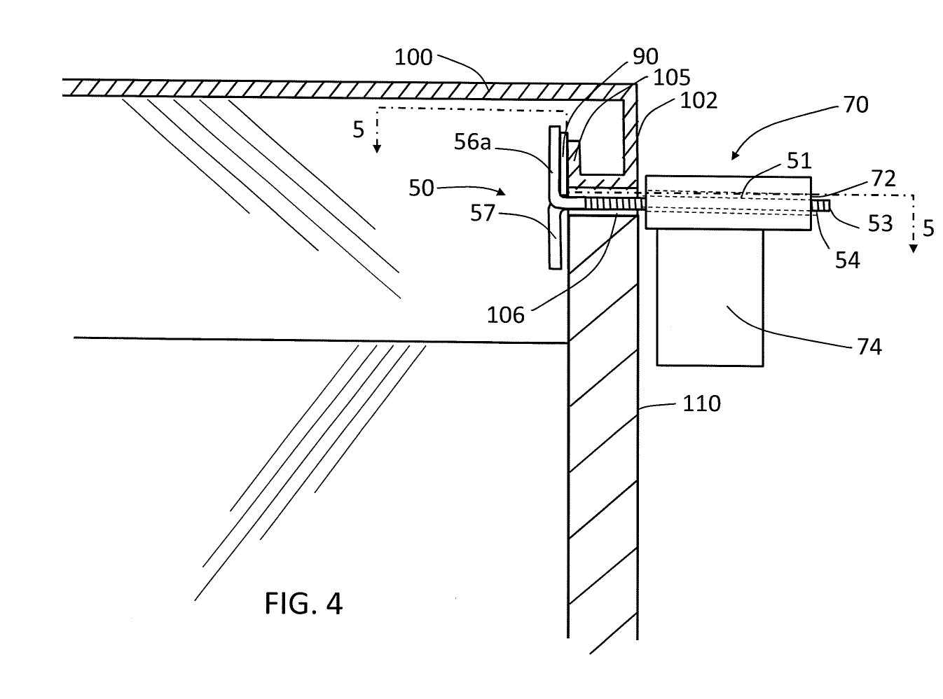

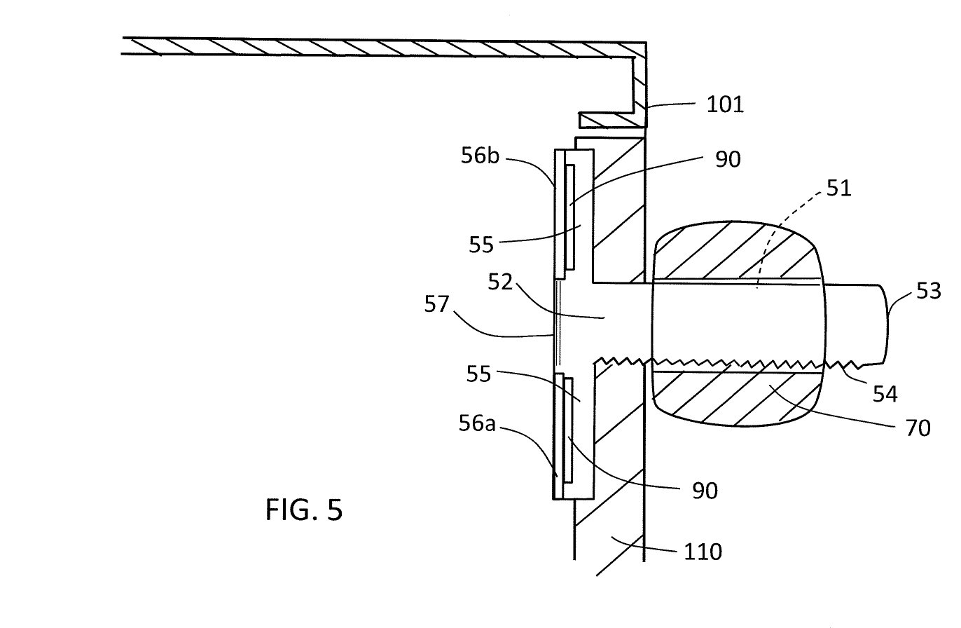

In one aspect of the invention, the locking device 50 is useful in locking the drawer of a file cabinet shown in FIGS. 2 through 5. The file cabinet includes a top surface 100, a front cabinet surface 102 having a file drawer frame 101, and a file drawer 110 disposed and movable laterally within the file drawer frame 101. The upper portion of file drawer frame 101 includes a horizontal wall 103 defining a portion of the drawer opening 104, and an interior vertical wall 105 extending perpendicularly from an inner edge of the horizontal wall 103. FIG. 2 shows the file drawer 110 in the open position, allowing a user to install the locking device 50. As shown in FIG. 3, after insertion into the opened file drawer 110, the upturned walls 56a and 56b are placed flush against the interior vertical wall 105, and the file drawer 110 is closed into the file drawer frame 101 with the locking end 53 of the elongated bar 51 extending through the upper slot 106 formed when the file drawer 110 is fully closed within the file drawer frame 101.

To temporarily fix the locking device 50 to the interior vertical wall 105, and prevent it from falling due to gravity, an attaching means 90 is secured to the forward-facing surface of the upturned walls 56a and 56b, and attached temporarily to the rearward-facing surface of interior vertical wall 105, to temporarily hold the locking device 50 in place, without manual support or holding, while the file drawer 110 is being closed. The attaching means 90 can include an adhesive material having a pressure-sensitive adhesive, or a magnetic material. A suitable magnetic material is a neodymium magnet.

Optionally the attaching end 52 can include at least one downturned wall 57 extending perpendicularly from the plane of the bar 51 at the attaching end 52. The upturned walls 56a and 56b and the downturned wall 57 provide a stop wall at the attaching end 52, which extends both above and below the planar bar 51. The upwardly extending wall(s) engages the interior vertical wall 105 of the file cabinet to anchor the locking device from being pulled through the drawer opening once the locking means has been applied to the device. The interior vertical wall 105 of a conventional file cabinet can be about 0.5-1 cm in height, such as 0.8 cm. Likewise, the downwardly extending wall prevents manipulating the locking device 50 through the upper gap 106 of the drawer opening once the locking means has been applied to the device.

One can appreciate that various configurations of an upwardly extending wall(s) can be employed that engage the interior vertical wall 105 to anchor the locking device from being pulled through the drawer opening once the locking means has been applied to the device. Likewise, various configurations of a downwardly extending wall can be employed that to prevent manipulating the locking device 50 through the drawer opening once the locking means has been applied to the device.

Once the locking device 50 is inserted into the drawer opening 104 and temporarily attached to the file drawer frame 101 using the attaching means 90, the file drawer 110 is closed, and a locking means, illustrated as a ratcheting lock 70, is installed over the rounded locking end 53 of the elongated bar 51 to engage ratchetingly the teeth 54 along the side edge of the bar 51, thereby securing closed the drawer 110. The ratcheting lock 70 can be disengaged from the teeth 54 by inserting and rotating the key 78 within the keyway of the cylinder lock portion 74, thereby allowing the ratcheting lock 70 to be slid off and removed from the locking end 53.

The width of the transverse base 55 of the locking device 50 is typically about 5 cm to about 12 cm, preferably from about 8 cm to about 10 cm. The upturned walls 56 and the downturned wall 57 are typically about 1 cm to about 2 cm in height.

Non-limiting examples of a material for the locking device include aluminum, hardened steel, tempered steel, chrome-plated steel, stainless steel, other metals and alloys, thermoplastic materials, including polycarbonate, acrylic, etc., and laminates and components thereof.

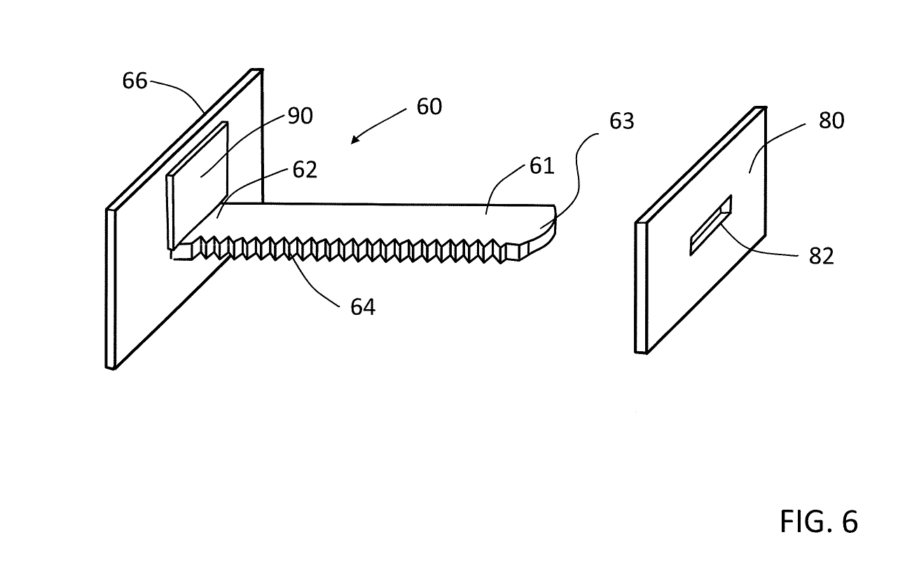

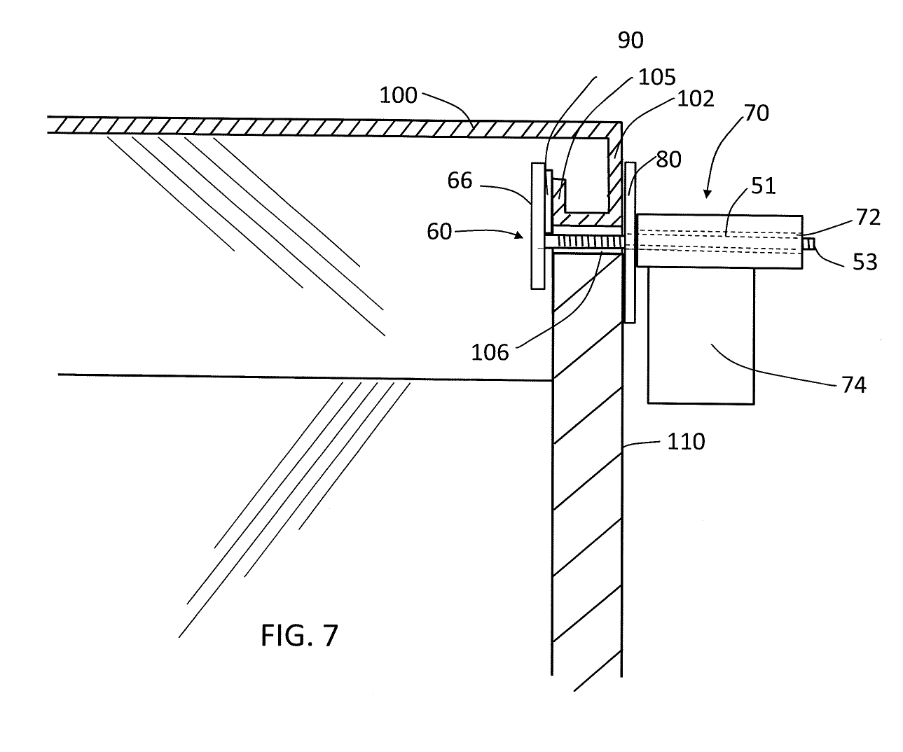

FIGS. 6 and 7 show an alternative embodiment of a locking device 60 including an elongated planar bar 61 having an attaching end 62 and a locking end 63. A perpendicular wall 66 is fixed to the attaching end 62 proximate the transverse center and slightly below the vertical center of the wall 66. An attaching means 90 can be fixed or attached to the inner surface of the wall 66, just above the bar 61.

Also illustrated in FIGS. 6 and 7 is a planar barrier plate or guard 80 having a transverse slot 82 sized to accommodate the size and shape of the bar 61 of the locking device. The guard 80 can be made of a plastic or any of the materials used for constructing the locking device. The planar surfaces of the guard can also be coated with a plastic material to reduce chipping or scratching of the surfaces of the file cabinet. The guard 80 protects against the lock 70 from marring the outer surface of the file drawer 110 and file drawer frame 101, as illustrated in FIG. 7. It is understood that a guard can be used with the first embodiment of the locking device shown in FIG. 1, or with any other embodiment herein.

FIG. 8 illustrates an alternative embodiment of the locking device wherein the attaching means is a hook and loop mechanical fastener. The fastener 92 is either the loop fastener member or the hook fastener member, which is typically attached adhesively to the forward-facing surface of the upturned walls 56a and 56b. The mating mechanical fastener 94 attached to the rearward-facing surface of the interior vertical wall 105 is the other of the loop fastener member or the hook fastener member, and is likewise typically attached adhesively.

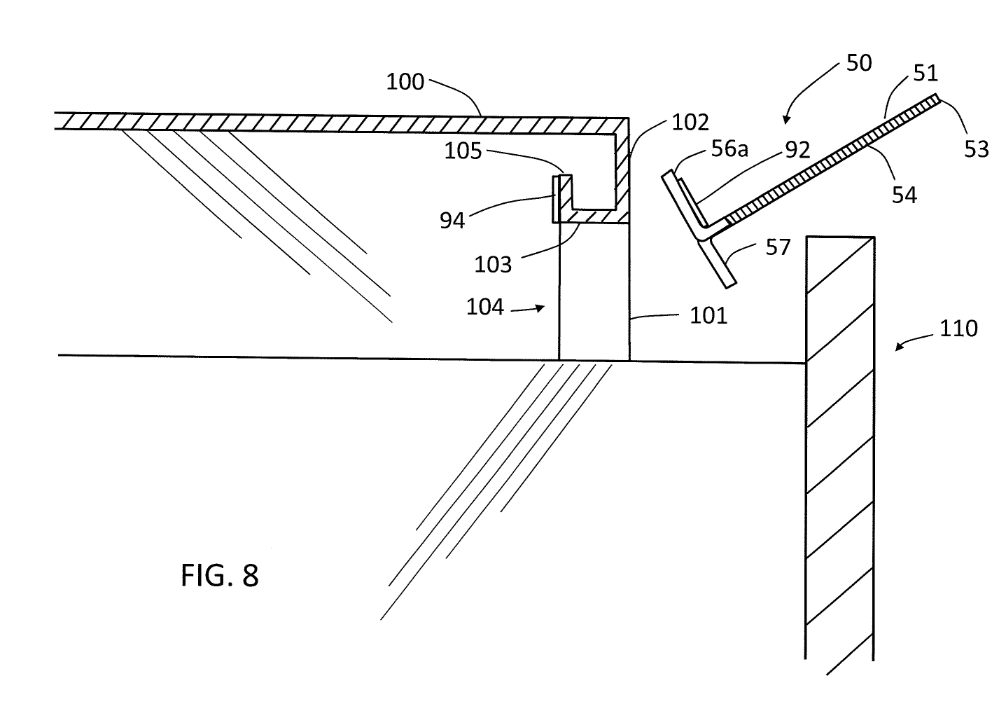

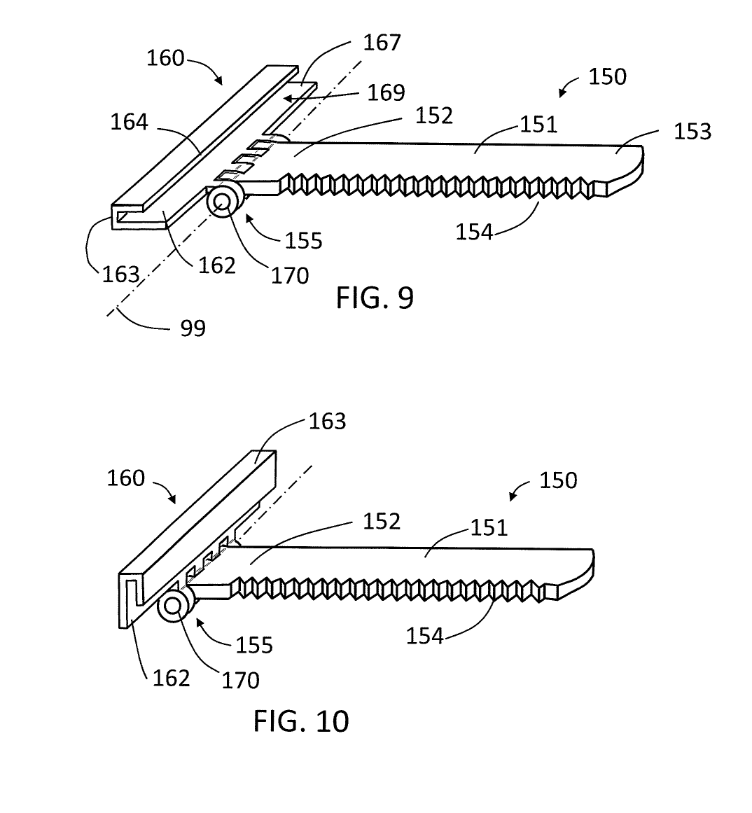

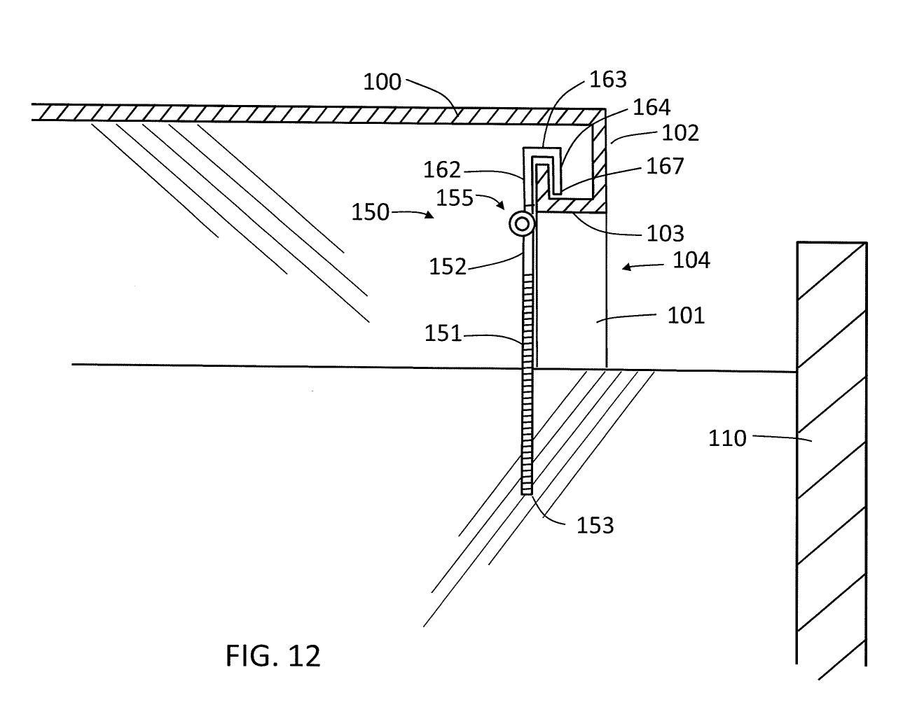

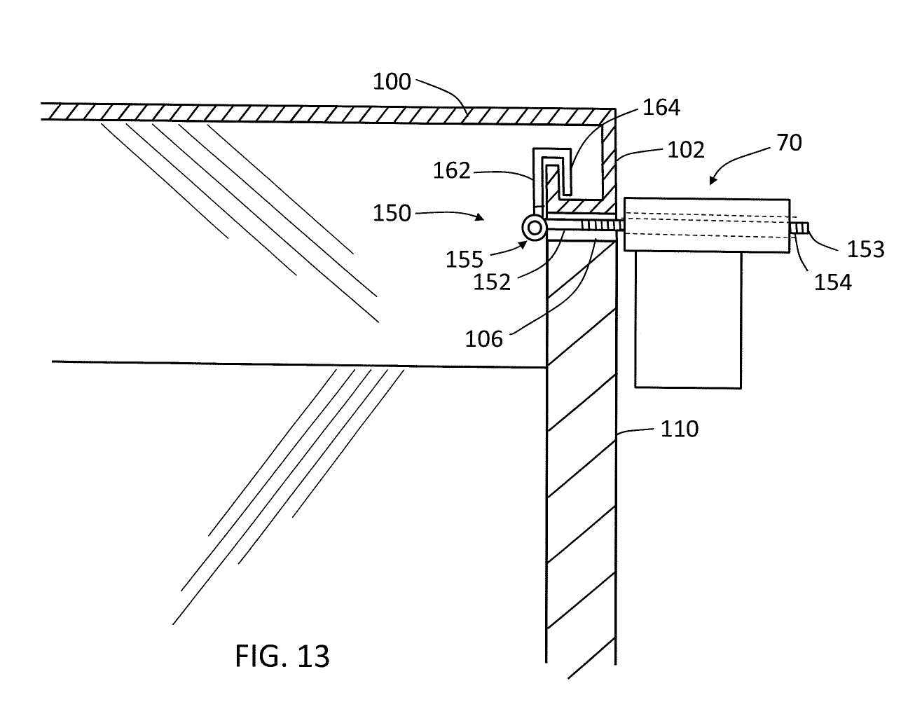

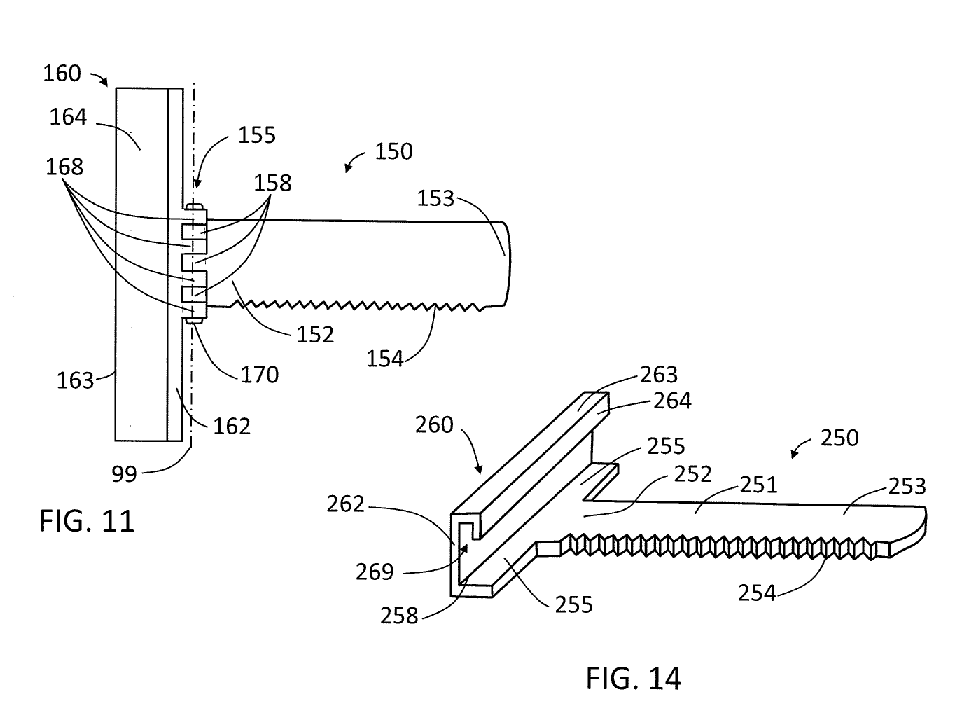

FIGS. 9-13 illustrate a third embodiment of the locking device 150 that employs a hooking member to grasp the top edge of the interior vertical wall 105 to prevent its withdrawal. The locking device 150 includes an elongated bar 151 that includes a locking end 153 and an opposing attaching end 152. A hinge 155 is secured to the attaching end 152 and to a hooking member 160 for pivoting movement of the hooking member 160 between an extended position shown in FIG. 9, and a hooked or installed position shown in FIG. 10. The hinge 155 can be any hinging member that allows the hooking member 160 to be moved or manipulated between the two positions. In the illustrated embodiment, shown in FIG. 11, the hinge 155 includes a plurality of circular loops 158 fixed to the distal edge of the attaching end 152 along an axis line 99, and a plurality of corresponding circular loops 168 extending from the proximal edge of the extending member 162 of the hooking member 160, and spaced between the loops 158. The loops 158 and 168 are interlaced pivotally along the axis 99 with an elongated pin 170. FIGS. 9 and 10 show the extending member 162 extending from the hinge 155, and the shorter clasping member 164 extending from the distal end 163 of the extending member 162 back toward the hinge, and spaced apart from the extending member 162 by a gap 169 having a dimension. The gap dimension is typically about 1 mm to about 2 mm. The gap accommodates insertion of the hooking member over a thickness of the upper edge of the interior vertical wall 105 of the file cabinet. Once hooked over the interior vertical wall 105, as shown in FIG. 12, any downward force or torque upon the locking device 150 ensures that the hooking member 160 does not disengage during use. The user grasps the locking end 153 of the bar 151 and holds it along the upper horizontal wall 103 while closing the file drawer 110, and locks the device with the locking means 70. The clasping member 164 can extend any distance back toward the hinge 155 that is sufficient to easily clasp the interior vertical wall 105, while remaining engaged with the top edge thereof. The confronting surfaces of the extending member 162 and the clasping member 164 do not need to grip the interior vertical wall 105, although the gap 169 should not be so large that the device could tilt over and off of the interior vertical wall 105.

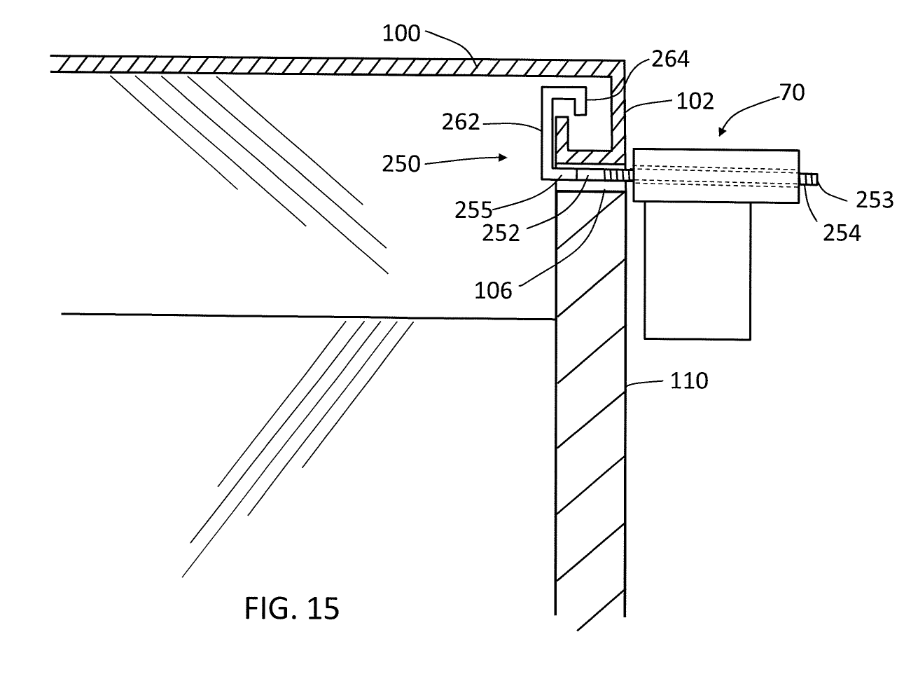

FIGS. 14 and 15 illustrate a fourth embodiment of the locking device 250 that employs a hooking member to grasp the top edge of the interior vertical wall 105 to assist in installation of the locking device, and to help prevent its withdrawal. The locking device 250 includes an elongated bar 251 that includes a locking end 253 and an opposed attaching end 252. A hooking member 260 includes an extending member 262 that extends from the attaching end 252, and a shorter return clasping member 264 that extends from the distal end 263 of the extending member 262 back toward the attaching end 252, and is spaced apart from the extending member by a gap 269 having a dimension, similar to that of the third embodiment. The attaching end 252 includes a transverse base 255 that extends from both side edges of the attaching end 252. The extending member 262 extends from the rearward edge 258 of the transverse base 255 on both sides of the elongated bar 251.

Once hooked over the interior vertical wall 105, any downward force or torque upon the locking device 250 ensures that the hooking member 260 does not disengage from the vertical wall 105 during the initial placement of the locking device 250 to the file drawer frame. The user manipulates the locking end 253 of the bar 251 and holds it along the upper horizontal wall 103 while closing the file drawer 110, and locks the device 250 with the locking means 70. The return clasping member 264 can extend any distance back toward the attaching end 252 that is sufficient to easily clasp the interior vertical wall 105, while remaining engaged with the top edge thereof and while providing a clearance to allow the forward-facing surface of the extending member 262 to fully contact the rearward-facing surface of the interior vertical wall 105. The confronting surfaces of the extending member 262 and the clasping member 264 do not need to grip the interior vertical wall 105, although the gap 269 should not be so large that the device could tilt over and off of the interior vertical wall 105.

The invention also relates to instructions associated with the use of the locking device with a file cabinet, directing the consumer as to the manner and means to insert and attach the locking device to the file cabinet, and to close and lock closed the drawer in the file cabinet. The invention also relates to a method of closing and locking a drawer of a file cabinet using the locking device. Typically the method for securing closed a drawer within a drawer opening of a file cabinet comprises the steps of: a) opening a drawer of a file cabinet; b) attaching the attaching end portion of the locking device to the file drawer frame of the file cabinet; c) closing the drawer to expose the locking end portion; and d) attaching a locking means to the locking end to prevent the drawer from opening within the drawer opening.

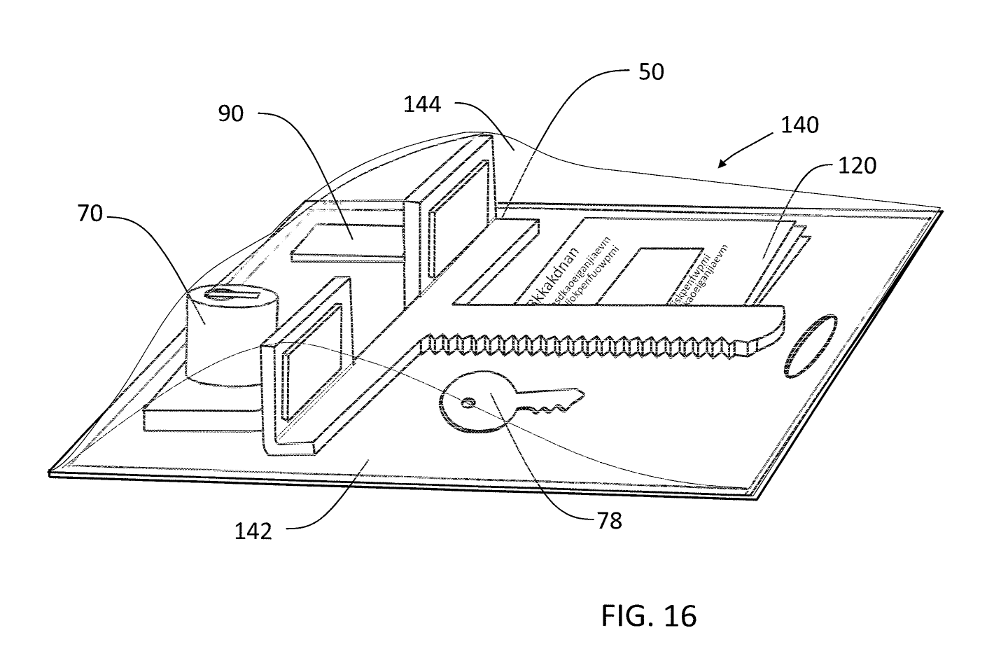

As illustrated in FIG. 16, the invention also relates to an article of manufacture 140 comprising the locking device 50, the locking means 70 and one or more keys 78, and optional fasteners 90, packaged in association with instructions 120 with a board 142 and clear overwrap 144, for use by a consumer of the locking device with a file cabinet, and with a method of locking and securing a drawer of the file cabinet using the locking device.

We claim:

1. A locking system for standard a file drawer cabinet, and in particular a steel-constructed file cabinet, including a locking device including an elongated bar that includes a locking end and an opposed attaching end, and an upturned wall extending from the attaching end perpendicularly from the elongated bar, and a locking means securable to the locking end.

2. The locking system of claim 1, wherein the locking end includes a plurality of teeth along a side edge of the elongated bar, and wherein the locking means comprises a ratcheting lock to engage ratchetingly the teeth to secure the locking means to the locking end of the locking device.

3. The locking system of claim 1, wherein a distal edge of the locking end is configured to extend forwardly less than about 3 inches from the upturned wall.

4. The locking system of claim 1, wherein the attaching end includes a transverse base portion extending laterally with or parallel to the plane of the elongated bar, wherein the upturned wall extends from the transverse base portion.

5. The locking system of claim 4, wherein the transverse base portion extends from both side edges of the attaching end.

6. The locking system of claim 1, wherein the upturned wall of the locking device has a forward-facing surface that faces the locking end, and the locking system further including a fastener attached to the forward-facing surface of the upturned wall.

7. The locking system of claim 6, wherein the fastener is selected from the group consisting of a pressure-sensitive adhesive layer, a hook and loop mechanical fastener, and a magnetic fastener.

8. The locking system of claim 1, further including a downturned wall extending perpendicularly from the attaching end and parallel with the upturned wall.

9. A locking system for a standard file drawer cabinet, and in particular a steel-constructed filing cabinet, including a locking device including an elongated bar that includes a locking end and an opposed attaching end, a hinge attached to the attaching end, and a hooking member extending from the hinge, the hooking member including an extending member having a distal end, and a return clasping member extending from the distal end of the extending member toward the hinge, and spaced apart from the extending member by a gap, wherein the gap accommodates insertion of the return clasping member over an upper edge of an interior vertical wall along an upper edge of a file drawer frame of a file cabinet, and a locking means securable to the locking end.

10. The locking system of claim 9, wherein the locking end includes a plurality of teeth along a side edge of the elongated bar, and wherein the locking means comprises a ratcheting lock to engage ratchetingly the teeth to secure the locking means to the locking end of the locking device.

11. The locking system of claim 9, wherein the locking end is configured to extend less than about 3 inches from the hinge.

12. The locking system of claim 9, further including a downturned wall extending perpendicularly from the attaching end.

13. A use of a locking system according to claim 1 for securing closed a file drawer within a file drawer opening of a filing cabinet, comprising the steps of:
a) opening a drawer of a file cabinet;
b) attaching the attaching end portion of the locking device to an interior vertical wall of a file drawer frame of the file cabinet;
c) extending the locking end through the drawer opening while closing the drawer, to expose the locking end through an upper slot between the file drawer and the file drawer frame; and
d) attaching the locking means of the locking system to the locking end portion to prevent the closed file drawer from opening within the drawer opening.

14. The use according to claim 13, wherein the locking end portion includes a plurality of lock engaging teeth along at least one side edge, and the locking means is a ratcheting lock.

15. The use according to claim 13, wherein the step of attaching the attaching end comprises adhering adhesively, magnetically or hook-and-loop mechanically the upturned wall of the interior vertical wall.

16. The use according to claim 15, wherein the locking means is a ratcheting lock and ratchetingly engages a row of teeth along a side edge of the elongated bar of the locking device.

17. A use of a locking system according to claim 9 for securing closed a file drawer within a file drawer opening of a filing cabinet, comprising the steps of:
a) opening a drawer of a file cabinet;
b) attaching the attaching end portion of the locking device to an interior vertical wall of a file drawer frame of the file cabinet;
c) extending the locking end through the drawer opening while closing the drawer, to expose the locking end through an upper slot between the file drawer and the file drawer frame; and
d) attaching the locking means of the locking system to the locking end portion to prevent the closed file drawer from opening within the drawer opening.

18. The use according to claim 17, wherein the step of attaching the attaching end comprises hooking the hooking member of the locking device over an upper edge of the interior vertical wall.

19. An article of manufacture comprising:
a) a locking device and optionally a lock and one or more keys,
b) instructions for use by a consumer of the locking device with a file cabinet, for locking and securing a drawer of the file cabinet using the locking device, and
c) a package for securing together the locking device, the optional lock and one or more keys, and the instructions.

20. The article of manufacture according to claim 19, wherein the instructions direct the consumer to attach the locking device to the file cabinet, and for closing and locking the drawer in the file cabinet.
